(19) United States
(12) Patent Application Publication
(10) Pub. No.: US 2021/0349912 A1
(43) Pub. Date: Nov. 11, 2021

(54) REDUCING RESOURCE UTILIZATION IN CLOUD-BASED DATA SERVICES

(71) Applicant: International Business Machines Corporation, Armonk, NY (US)

(72) Inventors: Tomasz Kania, Krakow (PL); Tymoteusz Gedliczka, Krakow (PL); Szymon Brandys, Krakow (PL); Piotr Grzywna, Krakow (PL); Maciej Madej, Krakow (PL); Krzysztof Pitula, Tarnow (PL)

(21) Appl. No.: 16/868,770

(22) Filed: May 7, 2020

(51) Int. Cl. G06F 16/25; G06N 20/00

(52) U.S. Cl. CPC G06F 16/258; G06Q 50/265; G06N 20/00

(57) ABSTRACT

In an approach to reducing resource utilization in cloud-based data services, one or more computer processors select a dataset for upload to a server. One or more computer processors determine a data transformation scheduled to be applied to the dataset by the server. One or more computer processors perform a dataset read on the dataset. One or more computer processors perform the data transformation on the dataset. One or more computer processors upload the transformed dataset to the server.

### BACKGROUND OF THE INVENTION

The present invention relates generally to the field of data processing, and more particularly to reducing resource utilization in cloud-based data services.

In computing, data transformation is the process of converting data from one format or structure into another format or structure and is a fundamental aspect of most data integration and data management tasks. Data transformation can be simple or complex based on the required changes to the data between the source (initial) data and the target (final) data. Data transformation can be performed via a mixture of manual and automated steps. Tools and technologies used for data transformation can vary widely based on the format, structure, complexity, and volume of the data being transformed. Data transformation can be divided into various steps, each applicable as needed based on the complexity of the transformation required, for example, data discovery, data mapping, code generation, code execution, and data review. The steps are often the focus of developers or technical data analysts who may use multiple specialized tools to perform the tasks.

A machine learning pipeline is used to help automate machine learning workflows. The machine learning pipeline operates by enabling a sequence of data to be transformed and correlated together in a model that can be tested and evaluated to achieve an outcome, whether positive or negative. As the word ‘pipeline’ suggests, a machine learning pipeline is a series of steps chained together in the machine learning cycle that may involve obtaining the data, processing the data, training and testing on various machine learning algorithms, and, finally, obtaining some output, for example, a prediction.

### SUMMARY

Embodiments of the present invention disclose a method, a computer program product, and a system for reducing resource utilization in cloud-based data services. The method may include one or more computer processors selecting a dataset for upload to a server. One or more computer processors determine a data transformation scheduled to be applied to the dataset by the server. One or more computer processors perform a dataset read on the dataset. One or more computer processors perform the data transformation on the dataset. One or more computer processors upload the transformed dataset to the server.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a data transformation program, on a client computing device within the distributed data processing environment of FIG. 1, for reducing resources used by a cloud-based service, in accordance with an embodiment of the present invention;

FIG. 3 depicts a block diagram of components of the client computing device executing the data transformation program within the distributed data processing environment of FIG. 1, in accordance with an embodiment of the present invention;

FIG. 4 depicts a cloud computing environment according to an embodiment of the present invention; and

FIG. 5 depicts abstraction model layers according to an embodiment of the present invention.

### DETAILED DESCRIPTION

Many cloud-based services, for example, machine learning cloud-based services, rely on uploaded data files, i.e., datasets, in various formats, such as a comma-separated values (CSV) file format. Often, upon uploading a dataset, the cloud-based service applies one or more data transformation steps. For example, machine learning pipelines contain transformation steps applied to each new data file as the file is uploaded. If a dataset is large, then the upload can take a significant amount of time and resources. In addition, a user may be charged for storage utilization, which can be more costly than necessary if the cloud-based service does not use the entire dataset. Embodiments of the present invention recognize that efficiency of cloud-based service resource utilization may be gained by performing one or more data transformations on the client side prior to uploading the dataset to the cloud-based service. By performing data transformations on the client side, upload time, network usage, and storage usage on the server side are reduced. In addition, if storage usage is reduced, the charges to the user may also be reduced. Implementation of embodiments of the invention may take a variety of forms, and exemplary implementation details are discussed subsequently with reference to the Figures.

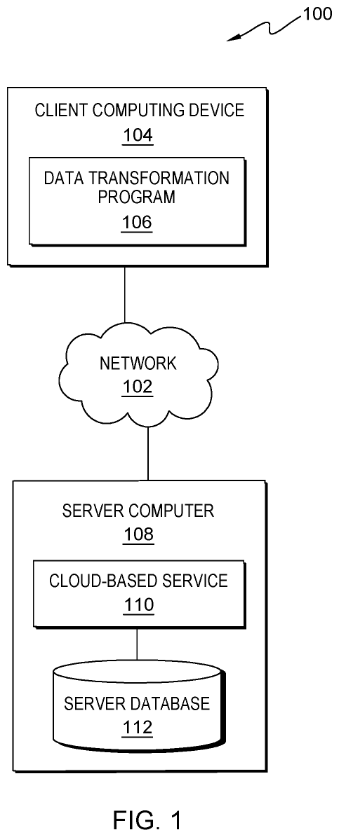

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes client computing device 104, and server computer 108 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between client computing device 104, server computer 108, and other computing devices (not shown) within distributed data processing environment 100.

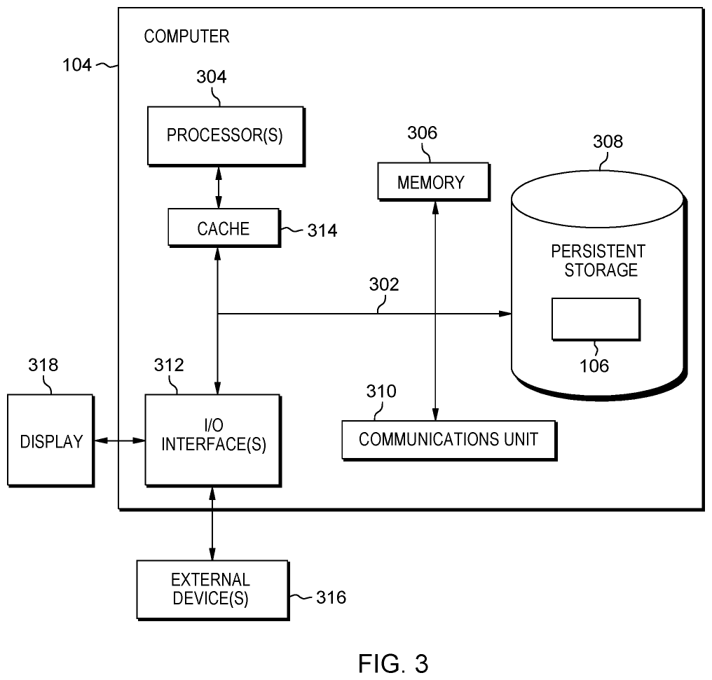

Client computing device 104 can be one or more of a laptop computer, a tablet computer, a smart phone, a smart watch, a smart speaker, or any programmable electronic device capable of communicating with various components and devices within distributed data processing environment 100, via network 102. Client computing device 104 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In one embodiment, the wearable computer may be in the form of a head mounted display. The head mounted display may take the form-factor of a pair of glasses. In an embodiment, the wearable computer may be in the form of a smart watch or a smart tattoo. In an embodiment, client computing device 104 may be integrated into a vehicle. For example, client computing device 104 may be a heads-up display in the windshield of the vehicle. In general, client computing device 104 represents one or more programmable electronic devices or combination of programmable electronic devices capable of executing machine readable program instructions and communicating with server computer 108 and other computing devices (not shown) within distributed data processing environment 100 via a network, such as network 102. Client computing device 104 includes data transformation program 106. Client computing device 104 may include internal and external hardware components, as depicted and described in further detail with respect to FIG. 3.

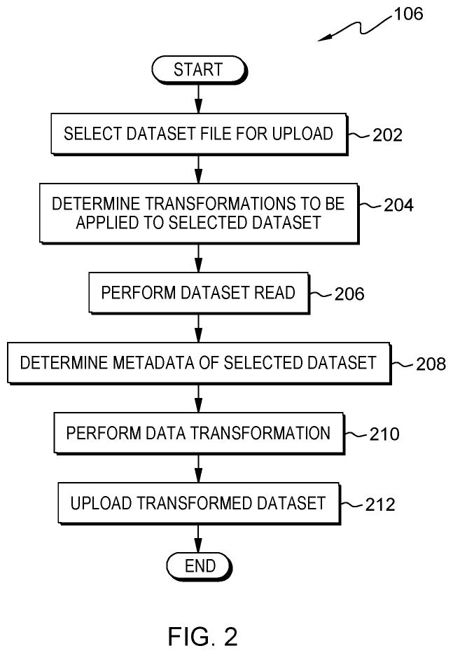

Data transformation program 106 performs data transformations on datasets on the client side of distributed data processing environment 100 such that the transformations are not performed on the server side, which can reduce upload time, network usage, and storage usage. Data transformation program 106 selects a dataset file to upload to cloud-based service 110. Data transformation program 106 determines what data transformations are planned to be applied to the selected dataset by cloud-based service 110. Data transformation program 106 performs a dataset read on the selected dataset. Data transformation program 106 determines metadata of the selected dataset. Data transformation program 106 performs one or more data transformations on the selected dataset. Data transformation program 106 uploads the transformed dataset to cloud-based service 110. In an embodiment, data transformation program 106 represents JavaScript® code executed directly on a web browser (not shown). (Java and all Java-based trademarks and logos are trademarks or registered trademarks of Oracle and/or its affiliates.) Data transformation program 106 is depicted and described in further detail with respect to FIG. 2.

Server computer 108 can be a standalone computing device, a management server, a web server, a mobile computing device, or any other electronic device or computing system capable of receiving, sending, and processing data. In other embodiments, server computer 108 can represent a server computing system utilizing multiple computers as a server system, such as in a cloud computing environment. In another embodiment, server computer 108 can be a laptop computer, a tablet computer, a netbook computer, a personal computer (PC), a desktop computer, a personal digital assistant (PDA), a smart phone, or any programmable electronic device capable of communicating with client computing device 104 and other computing devices (not shown) within distributed data processing environment 100 via network 102. In another embodiment, server computer 108 represents a computing system utilizing clustered computers and components (e.g., database server computers, application server computers, etc.) that act as a single pool of seamless resources when accessed within distributed data processing environment 100. Server computer 108 includes cloud-based service 110 and server database 112.

Cloud-based service 110 is one or more of a plurality of software entities that uses data to provide a service to one or more users over a network, such as network 102. A cloud service is any service made available to users on demand via the Internet from a cloud computing provider's server as opposed to being provided from a company's own on-premises servers. Cloud-based services are designed to provide easy, scalable access to applications, resources and services, and are fully managed by a cloud services provider. In an embodiment, cloud-based service 110 is a machine learning service. In other embodiments, cloud-based service 110 may be a storage service (e.g., a database), a computation service (e.g., a virtual machine or a docker container), a message queue service, etc.

Server database 112 is a repository for data used and transformed by data transformation program 106. Server database 112 can represent one or more databases. In the depicted embodiment, server database 112 resides on server computer 108. In another embodiment, server database 112 may reside elsewhere within distributed data processing environment 100, provided data transformation program 106 has access to server database 112. A database is an organized collection of data. Server database 112 can be implemented with any type of storage device capable of storing data and configuration files that can be accessed and utilized by data transformation program 106, such as a database server, a hard disk drive, or a flash memory. Server database 112 stores data uploaded by data transformation program 106 as well as any additional data used by cloud-based service 110. Server database 112 may also store one or more lists of dataset transformations required for one or more datasets.

The present invention may contain various accessible data sources, such as server database 112, that may include personal data, content, or information the user wishes not to be processed. Personal data includes personally identifying information or sensitive personal information as well as user information, such as tracking or geolocation information. Processing refers to any operating, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. In an embodiment, data transformation program 106 enables the authorized and secure processing of personal data. Data transformation program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Data transformation program 106 provides information regarding personal data and the nature (e.g., type, scope, purpose, duration, etc.) of the processing. Data transformation program 106 provides the user with copies of stored personal data. Data transformation program 106 allows the correction or completion of incorrect or incomplete personal data. Data transformation program 106 allows the immediate deletion of personal data.

FIG. 2 is a flowchart depicting operational steps of data transformation program 106, on client computing device 104 within distributed data processing environment 100 of FIG. 1, for reducing resources used by a cloud-based service, in accordance with an embodiment of the present invention.

Data transformation program 106 selects a dataset file for upload (step 202). In one embodiment, data transformation program 106 receives a selection of a dataset file from a user of client computing device 104. In another embodiment, data transformation program 106 may receive a list of one or more dataset files to select from a user of client computing device 104 via a user interface (not shown). In an embodiment, data transformation program 106 can select, or propose to a user of client computing device 104, a dataset file or format based on previous user selections. In another embodiment, data transformation program 106 selects a dataset file for upload based on a pre-defined list of files for upload. In the embodiment, the pre-defined list of files may be stored on server database 112. In an embodiment where cloud-based service 110 is a machine learning pipeline, data transformation program 106 selects a new data file to input to cloud-based service 110.

Data transformation program 106 determines transformations to be applied to the selected dataset (step 204). In an embodiment, data transformation program 106 communicates with cloud-based service 110 to determine which transformations cloud-based service 110 plans to perform on, i.e., are scheduled to be performed on or applied to, the selected dataset file. In another embodiment, data transformation program 106 may receive a list of one or more data transformations, or a set of data transformations, from a user of client computing device 104 via a user interface (not shown). Data transformations may include, but are not limited to, removal of columns, removal of rows, filtering of columns, filtering of rows, deidentification, deduplication, compression, transcoding, encryption, logarithmic transformation, square root, multiplicative inverse transformation, ranked transformation, Fischer transformation, Laplace transformation, and Box-cox transformation.

Data transformation program 106 performs a dataset read (step 206). In an embodiment, data transformation program 106 performs a memory non-intensive dataset read on the selected dataset file. By performing a memory non-intensive dataset read, data transformation program 106 does not load the full dataset into memory but reads and processes the data in chunk and/or stream form, thereby not impacting memory utilization of client computing device 104. In an embodiment, data transformation program 106 performs the memory non-intensive dataset read with a web browser (not shown) using JavaScript® code. In another embodiment, data transformation program 106 may perform the dataset read using a browser plugin or special software installed on client computing device 104 (not shown), which may be written in any programming language. In an embodiment, data transformation program 106 performs a data pass while performing the dataset read, i.e., reading all rows of data for at least one column in the dataset. For example, if data transformation program 106 determines a data transformation of filtering rows will be applied to the dataset, such as keeping rows with a value greater than 1980 in a year column, then data transformation program 106 performs a data pass to ready the values in the year column.

Data transformation program 106 determines metadata of the selected dataset (step 208). In an embodiment, data transformation program 106 determines metadata associated with the selected dataset based on the one or more transformations determined in step 204. Metadata may include, but is not limited to, a number of rows in the dataset, a number of columns in the dataset, and column types. For example, if data transformation program 106 determines a data transformation of removing a particular column from the dataset, then data transformation program 106 uses the metadata to determine whether that column is present in the dataset.

Data transformation program 106 performs a dataset transformation (step 210). In an embodiment, data transformation program 106 performs one or more simple data transformations on the selected dataset file. A simple data transformation is one that does not impact performance of client computing device 104. For example, data transformation program 106 may perform a data transformation such as removing one or more columns from the dataset file that will not be used by cloud-based service 110. Other examples of simple data transformations include, but are not limited to, removal of rows, filtering of columns, filtering of rows, replacing values in columns and/or rows, and renaming columns and/or rows. In another embodiment, data transformation program 106 may perform more complex data transformations in order to limit the use of resources on server computer 108, i.e., upload time, network usage, storage usage, etc. In an embodiment, data transformation program 106 determines which of the one or more data transformations scheduled to be performed by cloud-based service 110 are simple transformations, such that data transformation program 106 can determine which data transformations to perform. In an embodiment, data transformation program 106 performs the data transformation “on the fly,” during an upload process. In the embodiment, a user of client computing device 104 does not have to wait for data transformation program 106 to complete the data transformation before the upload step. In an embodiment, data transformation program 106 may perform the data transformation on the full dataset file, or on a chunk or stream of the dataset file, as would be recognized by one of skill in the art.

Data transformation program 106 uploads the transformed dataset (step 212). In an embodiment, data transformation program 106 uploads the transformed dataset directly to cloud-based service 110. In another embodiment, data transformation program 106 uploads the transformed dataset to server database 112 such that cloud-based service 110 can retrieve the transformed dataset file from server database 112 when needed. For example, if cloud-based service 110 is a machine learning pipeline, then cloud-based service 110 can retrieve the transformed dataset at a particular step in a sequence of steps. In the example, data transformation program 106 may perform one or more data transformations and upload the transformed dataset to cloud-based service 110. Then cloud-based service 110 performs actions such as calculations and/or creation of new data, after which additional data transformations, such as removal of one or more rows, are needed. A user can modify cloud-based service 110 such that communication is made to data transformation program 106 to perform the additional data transformations, e.g., the removal of rows, prior to the upload, thereby reducing additional resource usage by cloud-based service 110. In an embodiment where cloud-based service 110 is a machine learning pipeline, after data transformation program 106 uploads the transformed dataset, cloud-based service 110 performs checks and data transformations, where one or more required transformations were already performed by data transformation program 106. In the embodiment, cloud-based service 110 performs those data transformations anyway, but no changes in the dataset result. In the embodiment, no modifications to cloud-based service 110 are needed. In another embodiment, where cloud-based service 110 is a machine learning pipeline, data transformation program 106 provides information to cloud-based service 110 regarding the data transformations already performed by data transformation program 106, and cloud-based service 110 skips those data transformation steps.

FIG. 3 depicts a block diagram of components of client computing device 104 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Client computing device 104 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., data transformation program 106 are stored in persistent storage 308 for execution and/or access by one or more of the respective processor(s) 304 of client computing device 104 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of server computer 108. In these examples, communications unit 310 includes one or more network interface cards. Communications unit 310 may provide communications through the use of either or both physical and wireless communications links. Data transformation program 106 and other programs and data used for implementation of the present invention, may be downloaded to persistent storage 308 of client computing device 104 through communications unit 310.

I/O interface(s) 312 allows for input and output of data with other devices that may be connected to client computing device 104. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., data transformation program 106, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touch screen, such as a display of a tablet computer.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

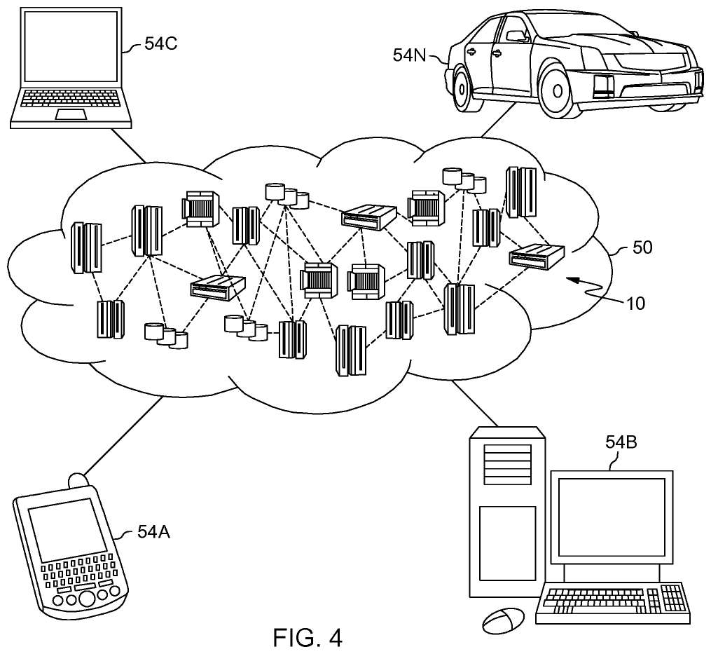

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

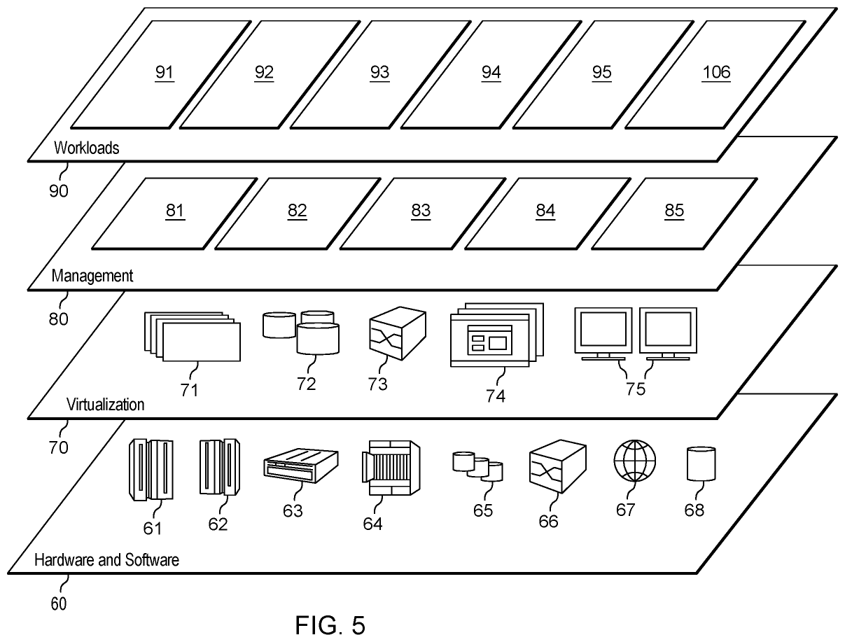

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data transformation program 106.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method, the method comprising:
selecting, by one or more computer processors, a dataset for upload to a server;
determining, by one or more computer processors, a data transformation scheduled to be applied to the dataset by the server;
performing, by one or more computer processors, a dataset read on the dataset;
performing, by one or more computer processors, the data transformation on the dataset; and
uploading, by one or more computer processors, the transformed dataset to the server.

2. The method of claim 1, further comprising, determining, by one or more computer processors, metadata of the dataset.

3. The method of claim 2, wherein the metadata is selected from the group consisting of a number of rows in the dataset, a number of columns in the dataset, and a column type in the dataset.

4. The method of claim 1, wherein performing the dataset read on the dataset further comprises performing, by one or more computer processors, a memory non-intensive dataset read on the dataset.

5. The method of claim 1, wherein the dataset includes input for a machine learning pipeline.

6. The method of claim 1, wherein the data transformation is selected from the group consisting of: removal of a column, removal of a row, filtering of a column, filtering of a row, deidentification, deduplication, compression, transcoding, encryption, a logarithmic transformation, a square root, a multiplicative inverse 2 transformation, a ranked transformation, a Fischer transformation, a Laplace transformation, and a Box-cox transformation.

7. The method of claim 1, wherein performing the dataset read on the dataset further comprises performing, by one or more computer processors, a data pass on the dataset.

8. A computer program product, the computer program product comprising:
one or more computer readable storage media and program instructions collectively stored on the one or more computer readable storage media, the stored program instructions comprising:
program instructions to select a dataset for upload to a server;
program instructions to determine a data transformation scheduled to be applied to the dataset by the server;
program instructions to perform a dataset read on the dataset;
program instructions to perform the data transformation on the dataset; and
program instructions to upload the transformed dataset to the server.

9. The computer program product of claim 8, the stored program instructions further comprising, program instructions to determine metadata of the dataset.

10. The computer program product of claim 9, wherein the metadata is selected from the group consisting of a number of rows in the dataset, a number of columns in the dataset, and a column type in the dataset.

11. The computer program product of claim 8, wherein the program instructions to perform the dataset read on the dataset comprise program instructions to perform a memory non-intensive dataset read on the dataset.

12. The computer program product of claim 8, wherein the dataset includes input for a machine learning pipeline.

13. The computer program product of claim 8, wherein the data transformation is selected from the group consisting of: removal of a column, removal of a row, filtering of a column, filtering of a row, deidentification, deduplication, compression, transcoding, encryption, a logarithmic transformation, a square root, a multiplicative inverse 2 transformation, a ranked transformation, a Fischer transformation, a Laplace transformation, and a Box-cox transformation.

14. The computer program product of claim 8, wherein the program instructions to perform the dataset read on the dataset further comprise program instructions to perform a data pass on the dataset.

15. A computer system, the computer system comprising:
one or more computer processors;
one or more computer readable storage media;
program instructions collectively stored on the one or more computer readable storage media for execution by at least one of the one or more computer processors, the stored program instructions comprising:
program instructions to select a dataset for upload to a server;
program instructions to determine a data transformation scheduled to be applied to the dataset by the server;
program instructions to perform a dataset read on the dataset;
program instructions to perform the data transformation on the dataset; and
program instructions to upload the transformed dataset to the server.

16. The computer system of claim 15, the stored program instructions further comprising, program instructions to determine metadata of the dataset.

17. The computer system of claim 16, wherein the metadata is selected from the group consisting of a number of rows in the dataset, a number of columns in the dataset, and a column type in the dataset.

18. The computer system of claim 15, wherein the program instructions to perform the dataset read on the dataset comprise program instructions to perform a memory non-intensive dataset read on the dataset.

19. The computer system of claim 15, wherein the dataset includes input for a machine learning pipeline.

20. The computer system of claim 15, wherein the data transformation is selected from the group consisting of: removal of a column, removal of a row, filtering of a column, filtering of a row, deidentification, deduplication, compression, transcoding, encryption, a logarithmic transformation, a square root, a multiplicative inverse 2 transformation, a ranked transformation, a Fischer transformation, a Laplace transformation, and a Box-cox transformation.
